(19) United States
(12) Patent Application Publication
(10) Pub. No.: US 2006/0130677 A1
(43) Pub. Date: Jun. 22, 2006

(54) Cake case

(76) Inventor: Hsin-Hung Chou, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/017,905

(22) Filed: Dec. 22, 2004

(51) Int. Cl. A47J 43/00

(52) U.S. Cl. 99/645

(57) ABSTRACT

A cake case is disclosed to include a base member, which has first female retainers and a second female retainer, and a cover member, which has first male retainers and a second male retainer respectively connectable to the first female retainers and second female retainer to lock the cover member to the base member upon a rotary motion of the cover member relative to the base member. Each first female retainer defines a single open-end retaining groove for receiving one first male retainer to limit the angle of rotation of the cover member on the base member. Each second male retainer has two raised portions that are respectively stopped at two sides of the second female retainer to lock the cover member to the base member after insertion of the second male retainer into the second female retainer.

### BACKGROUND OF THE INVENTION

a. Field of the invention

The present invention relates to a cake case and more particularly, to such a cake case, which can be locked when closed and can be conveniently opened after locking.

b. Description of the Related Art

A cake is a dessert made of flour, butter, and eggs, covered with a sweet frosting. For a birthday party, wedding anniversary, schoolmate meeting, or any of a variety of celebrating parties, people usually will prepare a cake. Usually, a cake for this purpose has a circular shape.

FIG. 1 shows a conventional cake case for carrying a circular cake. The cake case 10 comprises a flat base member 11 and a cover member 12 covering the base member 11. After closing of the cover member 12 on the base member 11, the cake case 10 is tied up with a ribbon 13, and then a handle 14 is fastened to the ribbon 13 for carrying by hand. It requires much time and labor to tie the cake case 10 with the ribbon 13. During wrapping, the ribbon 13 must be extended over the bottom side of the base member 11. When extending the ribbon 13 over the bottom side of the base member 11, the cake case 10 may be tilted accidentally, causing the cake to slope. If the ribbon 13 is not fastened tightly, the cake case 10 may fall from the ribbon 13. Further, when opening the cake case 10, the user must untie the ribbon 13.

There is a commercially available cake case without tying a ribbon. This structure of cake case can be locked when closed. However, this structure of cake case is not convenient in use. Further, it requires much effort to open the cake case. When opening the cake case, the cake may be damaged accidentally.

### SUMMARY OF THE INVENTION

The present invention has been accomplished under the circumstances in view. It is the main object of the present invention to provide a cake case, which can quickly be locked without the use of a ribbon. It is another object of the present invention to provide a cake case, which can conveniently be unlocked and opened simply by pressing a retainer with one finger of one hand and then rotating the cover member with the other hand. It is still another object of the present invention to provide a cake case, which can be conveniently smoothly be opened without moving the base member, thereby keeping the cake intact. To achieve these and other objects of the present invention, the cake case comprises a base member, and a cover member for covering the base member. The base member is circular plate member molded from plastics, having a plurality of first female retainers and a second female retainer equiangularly spaced around the periphery thereof at a top side. Each first female comprises a retaining groove and an angled retaining wall over the retaining groove. The retaining groove has an open end and a close end. The second female retainer is an angled spring plate member defining a transversely extending receiving space. The cover member comprises a plurality of first male retainers and a second male retainer equiangularly spaced around the bottom edge thereof and respectively connectable to the first female retainers and second female retainer of the base member. The first male retainers of the cover member are insertable into the retaining grooves of the first female retainers of the base member sideways. The second male retainer is insertable into the receiving space of the second female retainer, having a first raised portion and a second raised portion bilaterally disposed at a top side thereof for stopping at two sides of the second female retainer after insertion of the second male retainer into the receiving space of the second female retainer.

### BRIEF DESCRIPTION OF THE DRAWINGS

FIG. 1 is an elevational view of a cake case according to the prior art.

FIG. 2 is an exploded view of a cake case according to the present invention.

FIG. 3A is a schematic drawing of a part of the present invention before locking, showing the relationship between the first retainer of the base member and the respective first retainer of the cover member.

FIG. 3B is similar to FIG. 3A but showing the first retainer of the cover member engaged into the respective first retainer of the base member.

FIG. 4A is a schematic drawing of a part of the present invention before locking, showing the relationship between the second retainer of the base member and the second retainer of the cover member.

FIG. 4B is similar to FIG. 3A but showing the second retainer of the cover member engaged into the second retainer of the base member.

FIG. 5 is a perspective assembly view of the cake case according to the present invention.

FIG. 6 is a top view in an enlarged scale of a part of the cake case according to the present invention.

FIG. 7 is a sectional view taken along line 7-7 of FIG. 6.

FIG. 8 is a sectional view taken along line 8-8 of FIG. 6.

FIG. 9 is a sectional view taken along line 9-9 of FIG. 6.

FIG. 10 is a schematic drawing showing the cover unlocking operation according to the present invention.

FIG. 11 is a sectional view taken along line 11-11 of FIG. 10.

FIG. 12 is a schematic drawing showing the cover rotated in reversed direction and unlocked.

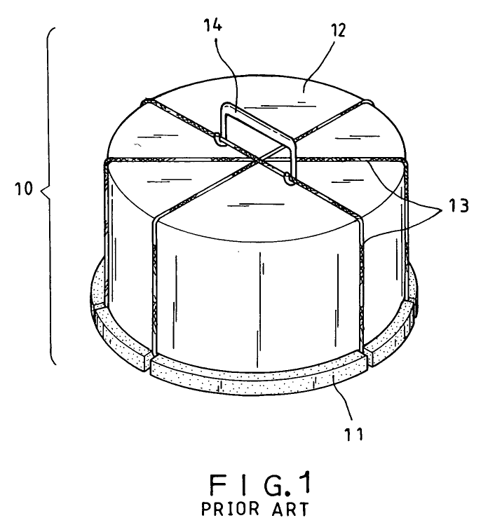

### DETAILED DESCRIPTION OF THE PREFERRED EMBODIMENTS

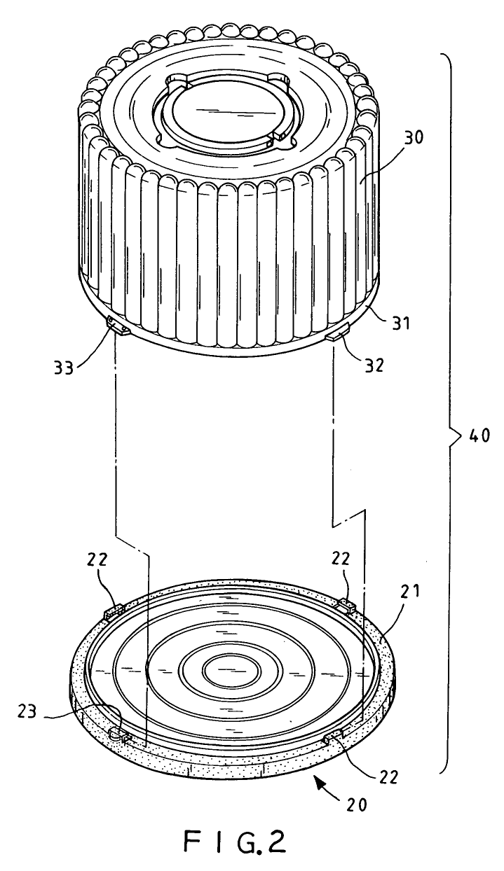

Referring to FIG. 2, a cake case 40 in accordance with the present invention is shown comprised of a base member 20 and a cover member 30.

The base member 20 is circular plate member molded from plastics, having a plurality of first retainers 22 and a second retainer 23 equiangularly spaced around the periphery 21 at the top. The cover member 30 has a plurality of first retainers 32 and a second retainer 33 equiangularly spaced around the bottom edge 31 corresponding to the first retainers 22 and second retainer 23 of the base member 20.

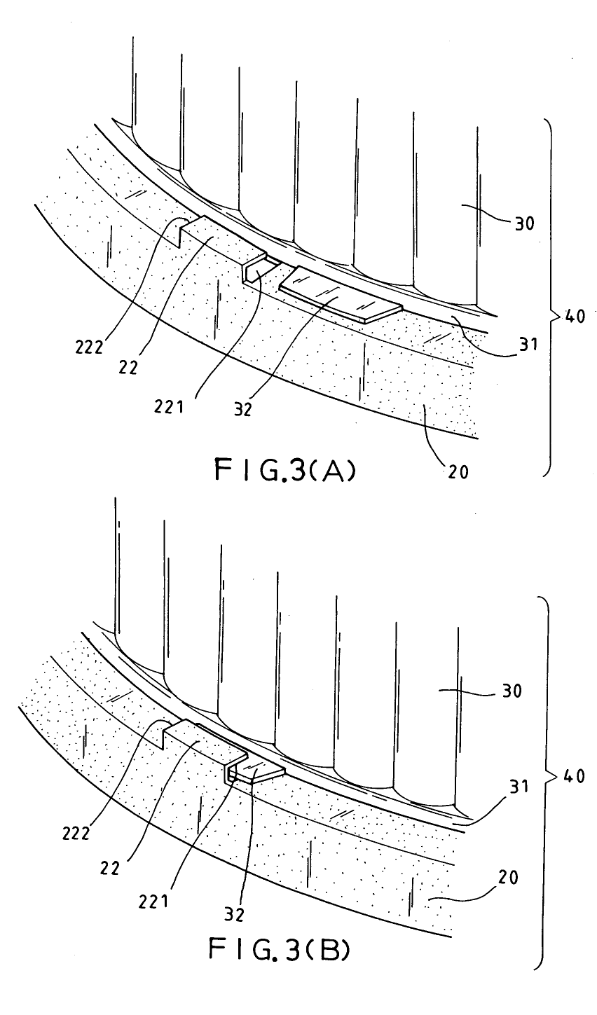

Referring to FIG. 3, the first retainers 22 of the base member 20 are female retainers, each comprising a retaining groove 221 and an angled retaining wall 222 over the retaining groove 221. The first retainers 32 of the cover member 30 are male retainers insertable into the retaining grooves 221 of the first retainers 22 of the base 20 sideways. After covering of the cover member 30 on the base member 20 from the top, the cover member 30 is rotated clockwise through an angle to insert the first retainers 32 of the cover member 30 into the retaining grooves 221 of the first retainers 22 of the base 20 respectively, keeping the first retainers 32 of the cover member 30 stopped against the angled retaining walls 222 of the first retainers 22 of the base 20 respectively.

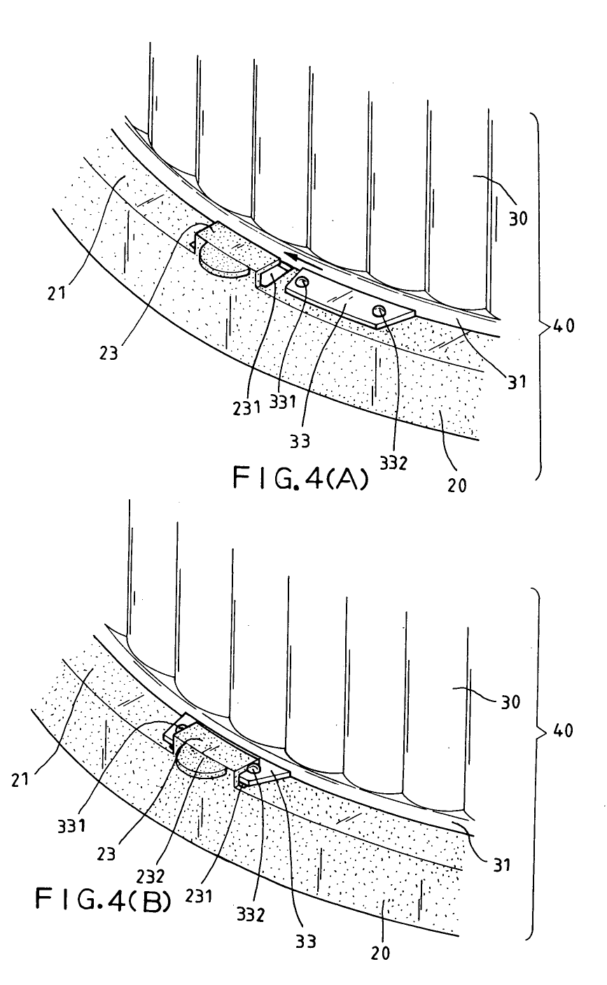

Referring to FIGS. 4A and 4B, the second retainer 23 of the base member 20 is an angled spring plate member defining a transversely extending receiving space 231; the second retainer 33 of the cover member 3 is a flat plate member insertable into the receiving space 231 of the second retainer 23 of the base member 20, having a first raised portion 331 and a second raised portion 332 bilaterally disposed at the top. The first raised portion 331 and the second raised portion 332 are spaced from each other at a pitch approximately equal to the length of the receiving space 231 of the second retainer 23 of the base member 20. After insertion of the second retainer 33 of the cover member 3 into the receiving space 231 of the second retainer 23 of the base member 20, the first raised portion 331 and the second raised portion 332 are respectively stopped at two sides of the second retainer 23 of the base member 20 to lock the cover member 30 to the base member 20.

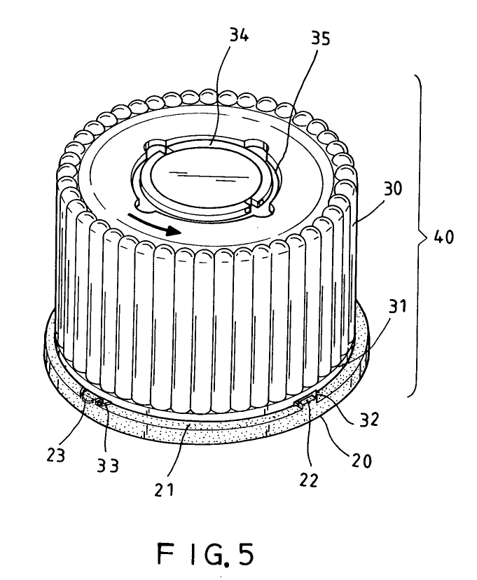

Referring to FIG. 5, the cover member 30 further comprises a top groove 35 in the top wall, and a handle 34 pivoted to the top wall and receivable in the top groove 35. Through the handle 34, the user can conveniently rotate the cover member 30 relative to the base member to force the first retainers 32 and second retainer 33 of the cover member 30 into engagement with the first retainers 22 and second retainer 23 of the base member 20. By means of handle 34, the user can also conveniently carry the cake case 40 with the hand.

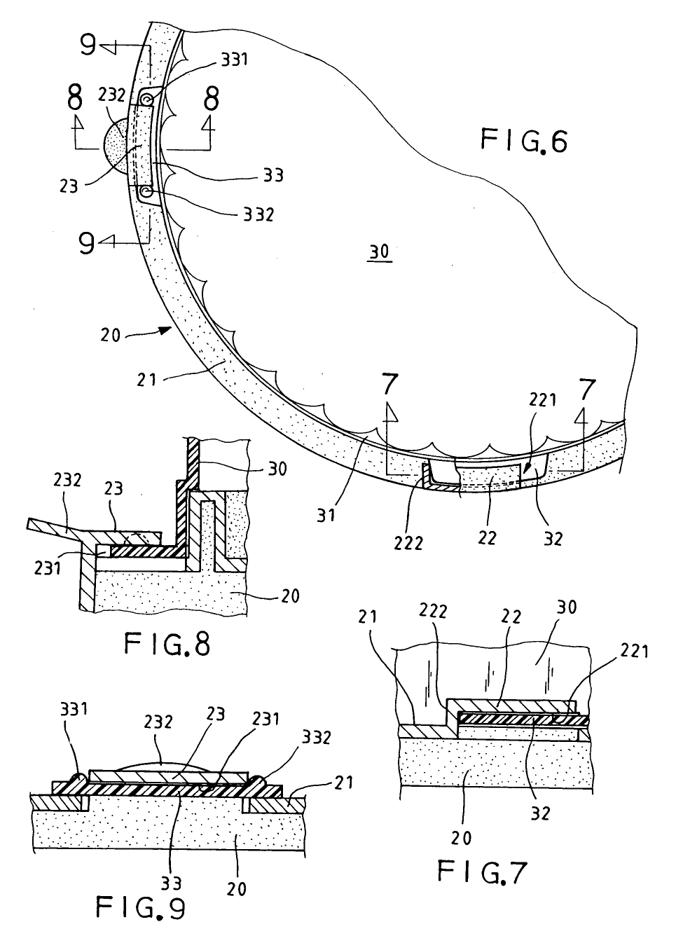

Referring to FIGS. 6-9, the retaining groove 221 of each of the first retainers 22 of the base 20 is a single open-end groove (i.e., the retaining groove 221 has one open end and one close end). Therefore, the cover member 30 can be rotated on the base member 20 in clockwise direction through a limited angle. After insertion of the first retainers 32 of the cover member 30 into the retaining grooves 221 of the first retainers 22 of the base 20, the first retainers 32 are respectively stopped at the close end of the retaining groove 221 of each of first retainers 22 of the base 20, and at the same time, the second retainer 33 of the cover member 30 is engaged into the receiving space 231 of the second retainer 23 of the base member 20 with the first raised portion 331 and the second raised portion 332 respectively stopped at two sides of the second retainer 23 of the base member 20 to lock the cover member 30 to the base member 20. According to the present preferred embodiment, the cover member 30 has a plurality of first retainers 32 and a second retainer 33 corresponding to the first retainers 22 and second retainer 23 of the base member 20. Actually, one single second retainer 23 at the base member 20 and one single second retainer 33 at the cover member 30 are sufficient to lock the cover member 30 to the base member 20.

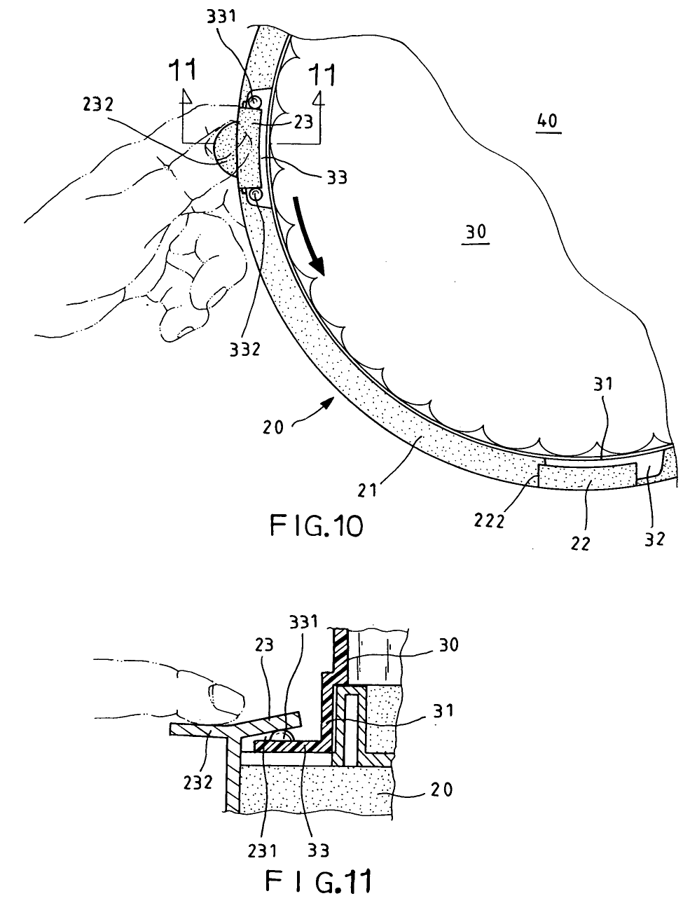

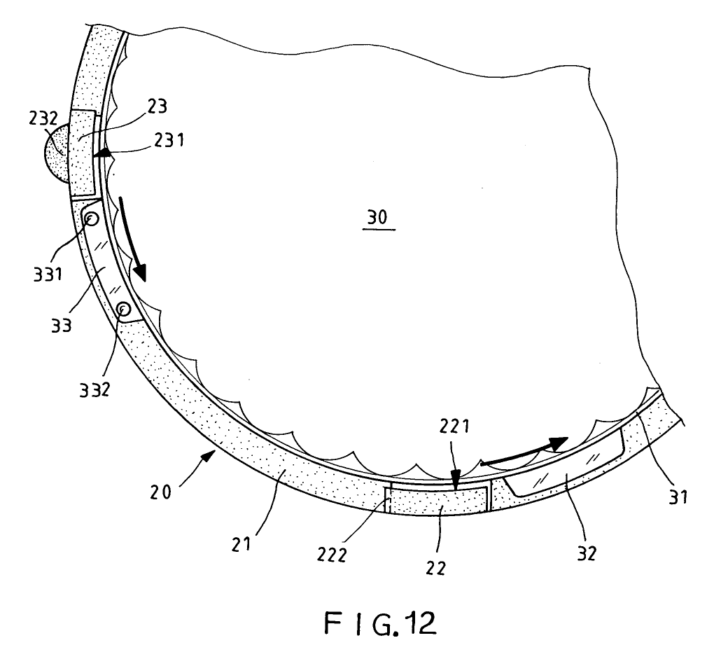

Referring to FIGS. 10-12, the second retainer 23 of the base member 20 has a finger strip 232. When unlocking the cover member 30 from the base member 20, press the finger strip 232 with the finger to disengage the second retainer 33 of the cover member 30 from the receiving space 231 of the second retainer 23 of the base member 20, and then rotate the cover member 30 on the base member 20 in counter-clockwise direction to move the first retainers 32 and second retainer 30 of the cover member 30 out of the first retainers 22 and second retainer 23 of the base member 20.

A prototype of cake case has been constructed with the features of FIGS. 2-12. The cake case functions smoothly to provide all of the features discussed earlier.

Although a particular embodiment of the present invention has been shown and described, it will be understood that various modifications and changes could be made thereunto without departing from the spirit and scope of the invention disclosed.

What is claimed is:

1. A cake case comprising a flat base member for holding a cake and a cover member for covering said flat base member, wherein:
said base member is circular plate member molded from plastics, having a plurality of first female retainers and a second female retainer equiangularly spaced around the periphery thereof at a top side, each said first female comprising a retaining groove and an angled retaining wall over said retaining groove, said retaining groove having an open end and a close end, said second female retainer being an angled spring plate member defining a transversely extending receiving space;
said cover member comprises a plurality of first male retainers and a second male retainer equiangularly spaced around a bottom edge thereof and respectively connectable to the first female retainers and second female retainer of said base member, said first male retainers of said cover member being insertable into the retaining grooves of said first female retainers of said base member sideways, said second male retainer being insertable into the receiving space of said second female retainer, having a first raised portion and a second raised portion bilaterally disposed at a top side thereof for stopping at two sides of said second female retainer after insertion of said second male retainer into the receiving space of said second female retainer.

2. The cake case as claimed in claim 1, wherein said cover member further comprises a handle pivotally provided at a top side thereof.
